(19) United States
(12) Patent Application Publication
(10) Pub. No.: US 2015/0193435 A1
(43) Pub. Date: Jul. 9, 2015

(54) VISUALIZING DOCUMENT REVISION HISTORY USING LAYERS

(71) Applicant: GOOGLE INC., Mountain View, CA (US)

(72) Inventor: Sandeep SIDDHARTHA, Hyderabad (IN)

(21) Appl. No.: 13/759,296

(22) Filed: Feb. 5, 2013

Related U.S. Application Data
(60) Provisional application No. 61/595,414, filed on Feb. 6, 2012.

(51) Int. Cl. G06F 17/30

(52) U.S. Cl. CPC G06F 17/30011

(57) ABSTRACT

Systems, servers, methods, media, and programs for generating a graphical comparison of data files are provided. A relationship is computed between a first data file and a second data file. The relationship represents at least one change from the first data file to the second data file. A transformation is computed in accordance with predefined transformation operations based on the relationship between the first data file and the second data file. The transformation includes at least one of the predefined transformation operations and is executable for representing the change from the first data file to the second data file. A graphical comparison of the data files is generated. The graphical comparison is configured to visualize the change from the first data file to the second data file by executing the transformation.

### BACKGROUND

1. Field of the Disclosure

The present disclosure generally relates to the field of document processing, and, in particular, to providing a graphical comparison of two or more documents.

2. Background Information

It is oftentimes desirable to compare two or more documents to provide an understanding of the differences and similarities of the documents. For example, it is oftentimes desirable to compare two versions of the same document in order to determine the changes made between the different versions.

The most common method of comparing two documents, or different versions of the same document, is the underline/strikethrough method. According to this method, information added to the documents is underlined while information deleted from the documents is stricken-through. This method, however, has numerous drawbacks, several being related to the basic nature in which the changes are represented. That is, the changes between the documents are represented in a single, merged document, including the cumulative text of both documents. The single, merged document may be lengthy, unclear, and visually unappealing.

Thus, alternative methods of providing a comparison of two or more documents are desired.

### SUMMARY OF THE DISCLOSURE

The present disclosure, through one or more of its various aspects, embodiments, and/or specific features or sub-components, provides various systems, servers, methods, media, and programs for generating a graphical comparison of data files.

According to the present disclosure a relationship between a first data file and a second data file is computed. The relationship represents at least one change from the first data file to the second data file. A transformation is computed in accordance with predefined transformation operations based on the relationship. The transformation includes at least one of the predefined transformation operations and is executable for representing the at least one change from the first data file to the second data file. Thereafter, a graphical comparison of the first and second data files is generated. The graphical comparison is configured to visualize the at least one change from the first data file to the second data file by executing the transformation.

Thus, according to the present disclosure, a graphical comparison of data files is provided in which changes between the data files are visualized by executing predefined transformation operations. In this regard, the changes between the data files are visually provided in an appealing manner. Moreover, according to non-limiting and exemplary embodiments of the present disclosure, the changes may be provided in a time varying manner and in accordance with customized, predefined transformation operations.

Accordingly, the present disclosure provides the non-limiting and advantageous effects of visualizing changes in appealing, time-varying, and customized formats. Moreover, the present disclosure provides the further non-limiting and advantageous effect of visualizing changes between data files in accordance with transformation operations, as opposed to the data files themselves, for reducing a size of the graphical comparison. Further benefits and advantages of the present disclosure are apparent from the various aspects and embodiments discussed in the Specification and shown in the Figures. The benefits and advantages may be individually provided by the various embodiments of the present disclosure and need not be provided in totality.

According to one non-limiting embodiment of the present disclosure, a server for generating a graphical comparison of data files is provided. The server includes at least one memory storing predefined transformation operations, and at least one processor. The processor is configured to compute a relationship between a first data file of the data files and a second data file of the data files. The relationship represents at least one change from the first data file to the second data file. The processor is further configured to compute, in accordance with the predefined transformation operations, a transformation based on the relationship between the first data file and the second data file. The transformation comprises at least one of the predefined transformation operations and is executable for visually representing the at least one change from the first data file to the second data file. The processor is further configured to generate the graphical comparison of the data files. The graphical comparison is configured to visualize the at least one change from the first data file to the second data file by executing the transformation.

According to one aspect of the present disclosure, the graphical comparison includes a plurality of layers that each correspond to one of the data files. The graphical comparison is configured to switch from displaying a first layer of the plurality of layers that corresponds to the first data file to displaying a second layer of the plurality of layers that corresponds to the second data file in response to a predetermined operation.

According to another aspect of the present disclosure, the graphical comparison is configured to execute the transformation after switching from displaying the first layer to displaying the second layer.

According to yet another aspect of the present disclosure, the transformation comprises a plurality of the predefined transformation operations. In this regard, the graphical comparison is configured to execute one of the plurality of the predefined transformation operations of the transformation after switching from displaying the first layer to displaying the second layer in response to a second predetermined operation.

According to still another aspect of the present disclosure, the at least one processor is further configured to compute, in accordance with the predefined transformation operation, a reverse transformation based on the relationship between the first data file and the second data file. The reverse transformation comprises at least one of the predefined transformation operations and is executable for visually representing the at least one change from the second data file to the first data file. The graphical comparison is configured to visualize the at least one change from the second data file to the first data file by executing the reverse transformation.

According to an additional aspect of the present disclosure, the graphical comparison is configured to switch from displaying the second layer that corresponds to the first data file to displaying the first layer that corresponds to the second data file in response to a second predetermined operation.

According to another aspect of the present disclosure, the graphical comparison is configured to display the transformation and the reverse transformation.

According to yet another aspect of the present disclosure, the processor is further configured to determine each of the data files. In this regard, the data files are snapshots of a document determined in accordance with a predetermined criteria.

According to still another aspect of the present disclosure, the first data file and the second file are consecutive ones of the snapshots.

According to an additional aspect of the present disclosure, the first data file and the second file are inconsecutive ones of the snapshots.

According to another aspect of the present disclosure, the processor is configured to determine a new one of the data files when a predetermined number of the predefined transformation operations is determined to exist between the first data file and the second data file.

According to yet another aspect of the present disclosure, the server further includes an input for receiving each of the predefined transformation operations.

According to still another aspect of the present disclosure, the predefined transformation operations comprise at least one of an appear operation, a disappear operation, a moveApart operation, and a comeCloser operation.

According to an additional aspect of the present disclosure, the system further includes a network interface that is configured to receive at least the first data file and the second data file via a network and to transmit the graphical comparison via the network.

According to another aspect of the present disclosure, the graphical comparison is at least one of searchable and filterable based on the predefined transformation operations.

According to yet another aspect of the present disclosure, the first data file and the second data file include image data. In this regard, the graphical comparison is configured to visualize the at least one change in the image data from the first data file to the second data file by executing the transformation.

According to another non-limiting embodiment of the present disclosure, a computer-implemented method for generating a graphical comparison of data files is provided. The computer-implemented method includes computing, with at least one processor, a relationship between a first data file of the data files and a second data file of the data files. The relationship represents at least one change from the first data file to the second data file. The computer-implemented method further includes computing, in accordance with predefined transformation operations, a transformation based on the relationship between the first data file and the second data file. The transformation comprises at least one of the predefined transformation operations and is executable for visually representing the at least one change from the first data file to the second data file. The computer-implemented method further includes generating, with the at least one processor, the graphical comparison of the data files. The graphical comparison is configured to visualize the at least one change from the first data file to the second data file by executing the transformation.

According to one aspect of the present disclosure, the graphical comparison includes a plurality of layers that each correspond to one of the data files. The graphical comparison is configured to switch from displaying a first layer of the plurality of layers that corresponds to the first data file to displaying a second layer of the plurality of layers that corresponds to the second data file in response to a predetermined operation. The graphical comparison is configured to execute the transformation after switching from displaying the first layer to displaying the second layer to visualize the at least one change from the first data file to the second data file.

According to a further non-limiting embodiment of the present disclosure, a non-transitory computer-readable medium including an executable program for generating a graphical comparison of data files is provided. The executable program, when executed, causes a computer to execute computing, with at least one processor, a relationship between a first data file of the data files and a second data file of the data files. The relationship represents at least one change from the first data file to the second data file. The executable program, when executed, further causes the computer to execute computing, in accordance with predefined transformation operations, a transformation based on the relationship between the first data file and the second data file. The transformation comprises at least one of the predefined transformation operations and is executable for visually representing the at least one change from the first data file to the second data file. The executable program, when executed, further causes the computer to execute generating, with the at least one processor, the graphical comparison of the data files. The graphical comparison is configured to visualize the at least one change from the first data file to the second data file by executing the transformation.

According to one aspect of the present disclosure, the graphical comparison includes a plurality of layers that each correspond to one of the data files. The graphical comparison is configured to switch from displaying a first layer of the plurality of layers that corresponds to the first data file to displaying a second layer of the plurality of layers that corresponds to the second data file in response to a predetermined operation. The graphical comparison is configured to execute the transformation after switching from displaying the first layer to displaying the second layer to visualize the at least one change from the first data file to the second data file.

### BRIEF DESCRIPTION OF THE DRAWINGS

The present invention is further described in the detailed description which follows, in reference to the noted plurality of drawings, by way of non-limiting examples of preferred embodiments of the present invention, in which like characters represent like elements throughout the several views of the drawings.

FIG. 1 is a schematic of an exemplary system for generating a graphical comparison of data files, according to an embodiment of the present disclosure.

FIG. 2 is a schematic of an exemplary system for generating a graphical comparison of data files, according to an additional embodiment of the present disclosure.

FIG. 3 is a schematic for generating a graphical comparison, according to an embodiment of the present disclosure.

FIG. 4 is a schematic of a graphical comparison, according to an embodiment of the present disclosure.

FIG. 5 is a flow chart of an exemplary method for generating a graphical comparison of documents, according to an embodiment of the present disclosure.

### DETAILED DESCRIPTION

The present disclosure, through one or more of its various aspects, embodiments and/or specific features or sub-components, is thus intended to bring out one or more of the advantages as specifically noted below.

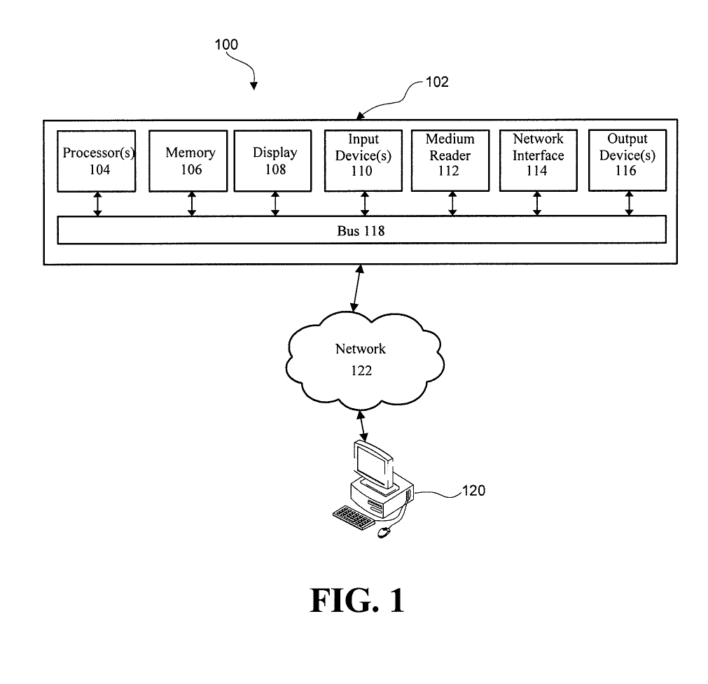

FIG. 1 is an illustrative embodiment of a system 100 for generating a graphical comparison of documents. The system 100 is generally shown and may include a computer system 102, which is generally indicated. The computer system 102 may operate as a standalone device or may be connected to other systems or peripheral devices. For example, the computer system 102 may include, or be included within, any one or more computers, servers, systems, or communication networks.

The computer system 102 may operate in the capacity of a server in a network environment, or the in the capacity of a client user computer in the network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that device. Further, while a single computer system 102 is illustrated, addition embodiments may include any collection of systems or sub-systems that individually or jointly execute instructions or perform functions.

As illustrated in FIG. 1, the computer system 102 may include at least one processor 104, such as, for example, a central processing unit, a graphics processing unit, or both. The computer system 102 may also include a computer memory 106. The computer memory 106 may include a static memory, a dynamic memory, or both. The computer memory 106 may additionally or alternatively include a hard disk, random access memory, a cache, or any combination thereof. Of course, those skilled in the art appreciate that the computer memory 106 may comprise any combination of known memories or a single storage.

As shown in FIG. 1, the computer system 102 may include a computer display 108, such as a liquid crystal display, an organic light emitting diode, a flat panel display, a solid state display, a cathode ray tube, a plasma display, or any other known display.

The computer system 102 may include at least one computer input device 110, such as a keyboard, a remote control device having a wireless keypad, a microphone coupled to a speech recognition engine, a camera such as a video camera or still camera, a cursor control device, or any combination thereof. Those skilled in the art appreciate that various embodiments of the computer system 102 may include multiple input devices 110. Moreover, those skilled in the art further appreciate that the above-listed, exemplary input devices 102 are not meant to be exhaustive and that the computer system 102 may include any additional, or alternative, input devices 110.

The computer system 102 may also include a medium reader 112 and a network interface 114. Furthermore, the computer system 102 may include any additional devices, components, parts, peripherals, hardware, software or any combination thereof which are commonly known and understood as being included with or within a computer system, such as, but not limited to, an output device 116. The output device 116 may be, but is not limited to, a speaker, an audio out, a video out, a remote control output, or any combination thereof.

Each of the components of the computer system 102 may be interconnected and communicate via a bus 118. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, or any other network commonly known and understood in the art. The network 122 is shown in FIG. 1 as a wireless network. However, those skilled in the art appreciate that the network 122 may also be a wired network.

The additional computer device 120 is shown in FIG. 1 as a personal computer. However, those skilled in the art appreciate that, in alternative embodiments of the present application, the device 120 may be a laptop computer, a tablet PC, a personal digital assistant, a mobile device, a palmtop computer, a desktop computer, a communications device, a wireless telephone, a personal trusted device, a web appliance, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

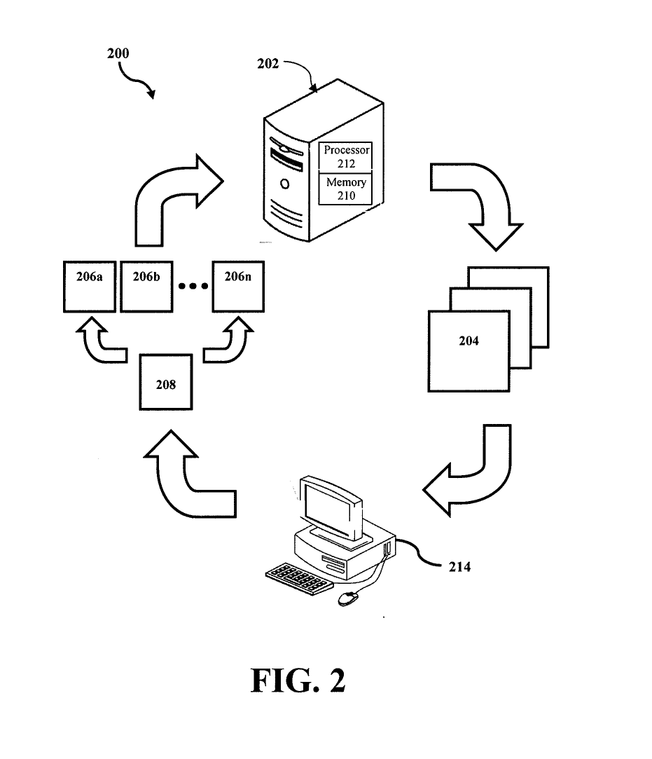

An exemplary embodiment of the system 100 is generally shown at 200 in FIG. 2. The system 200 includes a server 202, generally indicated, for generating a graphical comparison 204 of data files 206a, 206b, . . . 206n. The data files 206a, 206b, . . . 206n are shown in FIG. 2 as being derived from a single data file 208. However, those skilled in the art appreciate that the data files 206a, 206b, . . . 206n may be derived from multiple data files in additional embodiments of the present disclosure.

As shown in FIG. 2, the server 202 may include a memory 210 and a processor 212. The memory 210 may be equivalent or similar to the computer memory 106 as described with respect to FIG. 1. Furthermore, the processor 212 may also be equivalent or similar to the processor 104 as described with respect to FIG. 1. In this regard, in various embodiments of the server 202, the processor 212 may comprise a central processor, a graphics processor, or both. Those skilled in the art appreciate that the server 202 may include additional components such as, but not limited to, those described with respect to FIG. 1.

According to an embodiment of the present disclosure, the server 202 may include a network interface that is configured to receive the data files 206a, 206b, . . . 206n via a network. The network interface may be further configured to transmit the graphical comparison 204 via the network. The network interface and the network are not shown in FIG. 2, however, those skilled in the art appreciate that the network interface and the network may be equivalent or similar to the network interface 114 and the network 122 as described with respect to FIG. 1.

According to an embodiment of the server 202, the network interface may be configured to receive the data files 206a, 206b, . . . 206n from a client terminal 214 via the network. The client terminal 214 is shown in FIG. 2 as being a personal computer, however, those skilled in the art appreciate that the client terminal 214 may be any device such as, but not limited to, those described with respect to the additional computer device 120 of FIG. 1. According to various embodiments of the present disclosure in which the network interface is configured to receive the data files 206a, 206b, . . . 206n from the client terminal 214 via the network, the server 202 may generate the graphical comparison 204 of the received data files 206a, 206b, . . . 206n, and the network interface may be further configured to transmit the graphical comparison 204 to the client terminal 214 via the network.

For example, according to an exemplary embodiment of the present disclosure, the client terminal 214 may access the server 202 via the Internet, such as by initiating a hypertext transfer protocol request through a web browser. The client terminal 214 may then access applications or programs running on the server 202 for creating the data files 206a, 206b, . . . 206n, or the client terminal 214 may upload locally or remotely stored files for creating the data files 206a, 206b, . . . 206n. The server 202 may then generate the graphical comparison 204 of the data files 206a, 206b, . . . 206n, whereupon the server 202 may transfer the graphical comparison 204 to the client terminal 214. The client terminal 214 may download the graphical comparison 204 for locally storing and accessing the graphical comparison 204. Of course, in further embodiments, the graphical comparison 204 may be stored by the server 202 wherein the client terminal 214 may remotely access the graphical comparison 204, such as via the web browser.

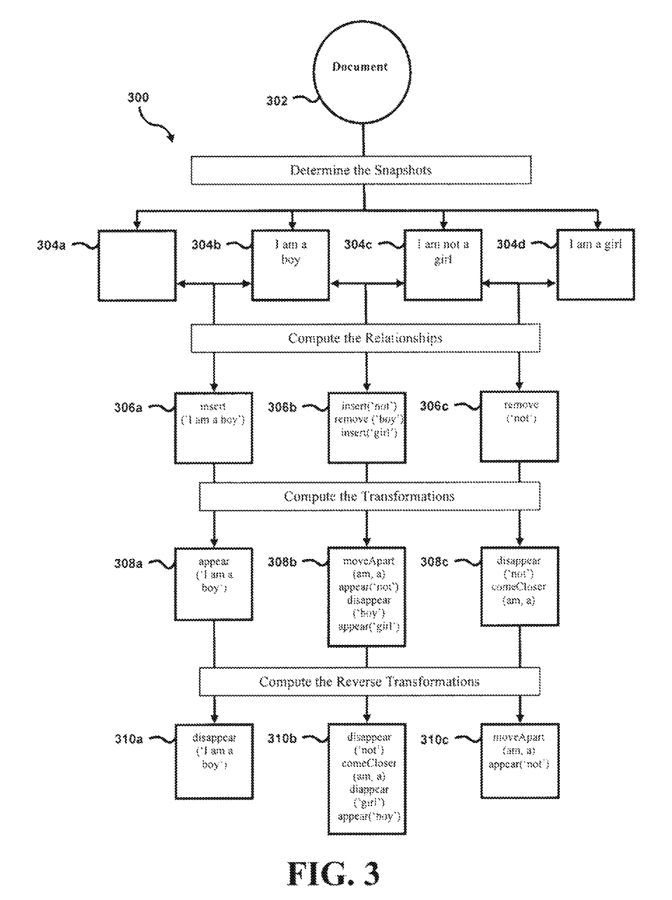

A schematic of an embodiment of the present disclosure for generating the graphical comparison 204 is generally shown at 300 in FIG. 3. According to the schematic 300, the graphical comparison 204 is generated from a single document 302. However, those skilled in the art appreciate that graphical comparison 204 may be generated from multiple documents in additional embodiments of the present disclosure without departing from the scope of the present disclosure.

According to an embodiment of the present disclosure, the document 302 may comprise any blob of textual data. For example, the document 302 may be, but is not limited to, a file containing text, an email message, a spreadsheet, and a presentation. The textual data may or may not be interspersed with non-textual data. For example, in additional embodiments, the document 302 may include, in addition or alternatively to the textual data, image data, charts, graphs, figures, or any combination thereof. Of course, those skilled in the art appreciate that the above-mentioned document 302 and data types are not meant to be limiting or exhaustive. That is, the document 302 may comprise any type of document and data, or combinations thereof, which are generally known and understood in the art.

According to the embodiment of the server 202 as shown in FIG. 2, the processor 212 is configured to determine the data files 206a, 206b, . . . 206n from the data file 208. In this regard, the data files 206a, 206b, . . . 206n are shown in FIG. 3 as being snapshots 304a-d of the document 302 that are determined in accordance with a predetermined criteria. For example, the snapshots 304a-d of the document 302 may be determined in accordance with an elapse of a predetermined period of time. In additional embodiments, the snapshots 304a-d may be determined each time that the document 302 is saved or each time that the document 302 is saved as a different version. In even further embodiments, the snapshots 304a-d may be determined each time that a different user edits or accesses the document 302. As such, the snapshots 304a-d may each be associated with a particular user. Of course, those skilled in the art appreciate that the snapshots 304a-d may be determined in accordance with any additional, or alternative, criteria. For example, each character change in the document 302 may constitute a snapshot, a new one of the snapshots 304a-d may be created each time a predetermined number of changes are made in the document 302, or a new one of the snapshots 304a-d may be created each time a predetermined type of change is made in the document 302. Of course, the above-mentioned criteria are merely meant to be exemplary and are not meant to be limiting. In further embodiments of the server 202, the processor 212 may be configured to determine the snapshots 304a-d in accordance with any additional, alternative, or combination of criteria. The snapshots 304a-d may be versions of the document 302, or documents, which are of interest.

With respect to FIG. 3 as a non-limiting and exemplary embodiment of the present disclosure, a first snapshot 304a may initially be determined when the document 302 is empty. Thereafter, the document 302 may be edited to comprise the text string “I am a boy,” and a second snapshot 304b may be determined by the processor 212. Then, the document 302 may be edited to comprise the text string “I am not a girl,” and a third snapshot 304c may be determined by the processor 212. Finally, the document 302 may be further edited to comprise the text string “I am a girl,” and a fourth snapshot 304d may be determined by the processor 212.

The snapshots 304a-d as shown in FIG. 3 may be ordered chronologically. In this regard, the relationships 306a-c and the transformations 308a-c may be computed between consecutive ones of the snapshots 304a-d. The relationships 306a-c and the transformations 308a-c are described below. In further embodiments of the server 202, the relationships 306a-c and the transformations 308a-c may be computed between inconsecutive ones of the snapshots 304a-d. In even further embodiments of the server 202, the relationships 306a-c and the transformations 308a-c may be computed between consecutive ones of the snapshots 304a-d and between inconsecutive ones of the snapshots 304a-d. For example, in the schematic 300 shown in FIG. 3, the first relationship 306a and the first transformation 308a may be computed between the snapshot 304a and the snapshot 304b, and an additional relationship (not shown) and an additional transformation (not shown) may be computed between the first snapshot 304a and the snapshot 304c.

In additional embodiments of the schematic 300 as shown in FIG. 3, the snapshots 304a-d may be ordered in accordance with a criteria other than time. For example, the snapshots 304a-d may be ordered in accordance with authors of the snapshots 304a-d or a location or proximity of changes or edits in the document 302. Of course, the snapshots 304a-d may be ordered in accordance with additional or alternative criteria.

According to an embodiment of the server 202, each of the snapshots 304a-d of the document 302 is used in constructing a layer of the graphical comparison 204. In this regard, with respect to FIG. 2, the processor 212 of the server 202 is configured to compute relationships 306a-c between the data files 206a, 206b, . . . 206n. For example, the processor 212 is configured to compute a relationship between a first data file 206a of the data files 206a, 206b, . . . 206n and a second data file 206b of the data files 206a, 206b, . . . 206n. With respect to FIG. 3, the processor 212 is configured to compute the relationships 306a-c between the snapshots 304a-d. The processor 212 is discussed herein, at times, as only computing the relationships 306a-c between the snapshots 304a-d or only as computing the relationship between the first snapshot 304a and the second snapshot 304b, as shown in FIG. 3. However, those skilled in the art appreciate that the processor 212 may compute the relationships 306a-c between any or all of the snapshots 304a-d of FIG. 3 and between any or all of the data files 206a, 206b, . . . 206n of FIG. 2 without departing from the scope of the present disclosure.

The relationships 306a-c represent changes or edits between the snapshots 304a-d. According to an embodiment of the server 202, each of the relationships 306a-c represents at least one change between a pair of the snapshots 304a-d. According to additional embodiments, each of the relationships 306a-c may represent a plurality of changes between a pair of the snapshots 304a-d. For example, with respect to FIG. 3 as a non-limiting and exemplary embodiment, if the first snapshot 304a comprises the empty text string and the second snapshot 304b comprises the text string of “I am a boy,” the processor 212 may determine the relationship between the first snapshot 304a and the second snapshot 304b to be insert (‘I am a boy’). Moreover, if the second snapshot 304b comprises the text string of “I am a boy” and the third snapshot 304c comprises the text string of “I am not a girl,” the processor 212 may determine the relationship between the first snapshot 304a and the second snapshot 304b to be insert (‘not’), remove (‘boy’), insert (‘girl’). Lastly, if the third snapshot 304c comprises the text string of “I am not a girl” and the fourth snapshot 304d comprises the text string of “I am a girl,” the processor 212 may determine the third relationship 306c between the third snapshot 304c and the fourth snapshot 304d to be remove (‘not’). Of course, those skilled in the art appreciate that the above-listed examples are merely meant to be exemplary and are not intended to be limiting in any way. That is, the relationships 306a-c may represent the change or changes between the snapshots 304a-d in accordance with any known or generally understood method.

According to an embodiment of the server 202, the processor 212 is configured to compute the relationships 306a-c between the snapshots 304a-d in accordance with a predetermined metric or algorithm. For example, the processor 212 may be configured to compute the relationships 306a-c in accordance with the Levenshtein distance metric. In this regard, the processor 212 may use words of the snapshots 304a-d as building blocks of the document 302 and compute the Levenshtein distance, considering the words to be the atomic units in a piece of text. Of course, those skilled in the art appreciate that the processor 212 may also be configured to compute the relationships 306a-c in accordance with any additional or alternative metrics or algorithms. In embodiments of the server 202, the processor 212 may compute the relationships 306a-c between the snapshots 304a-d granularly at a character-by-character level or at a word-by-word level.

The processor 212 is further configured to compute transformations 308a-c between the data files 206a, 206b, . . . 206n based on the relationships 306a-c. For example, the processor 212 is configured to compute a transformation between the first data file 206a of the data files 206a, 206b, . . . 206n and the second data file 206b of the data files 206a, 206b, . . . 206n. In this regard, while the relationships 306a-c represent changes between the data files 206a, 206b, . . . 206n, the transformations 308a-c comprise operations or functions for visually representing the changes. In other words, the transformations 308a-c are executable for graphically showing the changes while the relationships 306a-c describe the changes or differences.

With respect to FIG. 3, the processor 212 is configured to compute the transformations 308a-c between the snapshots 304a-d. The processor 212 is discussed herein, at times, as only computing the transformations 308a-c between the snapshots 304a-d or only as computing the transformations 308a-c between the first snapshot 304a and the second snapshot 304b, as shown in FIG. 3. However, those skilled in the art appreciate that the processor 212 may compute the transformations 308a-c between any or all of the snapshots 304a-d of FIG. 3 and between any or all of the data files 206a, 206b, . . . 206n of FIG. 2 without departing from the scope of the present disclosure.

The processor 212 of the server 202 is configured to compute the transformations 308a-c in accordance with predefined transformation operations that are stored in the memory 210 of the server 202. Each of the transformations 308a-c comprises at least one of the predefined transformation operations and is executable for visually representing the change or changes from the first data file to the second data file that is or are represented by the corresponding one of the relationships 306a-c.

The predefined transformation operations may include, but are not limited to: a rotation operation for rotating text, image, or other data; a translation operation for linearly moving text, image, or other data; an appear operation for causing text, image, or other data to appear; a disappear operation for causing text, image, or other data to disappear; a shrink operation for shrinking text, image, or other data; an expand operation for expanding text, image, or other data; a moveApart operation for moving text, image, or other data apart; and a comeCloser operation for moving text, image, or other data closer together. The above-listed operations are merely meant to be exemplary and are not inclusive or exhaustive. Any additional operations that are commonly known and understood are within the purview of the present application.

In this regard, with respect to FIG. 3 as a non-limiting and exemplary embodiment, if the first relationship 306a between the first snapshot 304a and the second snapshot 304b is insert (‘I am a boy’), the processor 212 may compute the first transformation 308a to be appear (‘I am a boy’). If the second relationship 306b between the first snapshot 304a and the second snapshot 304b is insert (‘not’), remove (‘boy’), insert (‘girl’), the processor 212 may compute the second transformation 308b to be moveApart (am, a), appear (‘not’), disappear (‘boy’), appear (‘girl). Finally, if the third transformation 308c between the third snapshot 304c and the fourth snapshot 304d is remove (‘not’), the processor 212 may compute the third transformation 308c to be disappear (‘not’), comeCloser (am, a). Of course, those skilled in the art appreciate that the above-listed examples are merely meant to be exemplary and are not intended to be limiting in any way. That is, the transformations 308a-c may comprise any operations that are executable for visually representing the change or changes between the snapshots 304a-d.

As shown in FIG. 3, the transformations 308a-c may comprise a single predefined transformation operation or multiple predefined transformation operations. In this regard, according to an embodiment of the server 202, the server 202 may include an input that is configured to receive the predefined transformation operations. The input is not shown in FIG. 2, however, those skilled in the art appreciate that the input may be equivalent or similar to the input device 110 as described with respect to FIG. 1. Thus, according to such an embodiment, an end user or client operating the client terminal 214 may program or configure the manner in which the change or changes between the snapshots 304a-d or data files 206a, 206b, . . . 206n is visually represented. Provided that the end user or client understands the manner in which the relationships 306a-c are computed, the end user or client may customize the transformations 308a-c to visually represent the relationships 306a-c in an appealing form.

The transformations 308a-c are provided in FIG. 3 so as to correspond to all of the relationships 306a-c. However, in further embodiments of the present disclosure, the transformations 308a-c need not correspond to all of the relationships 306a-c. In other words, the transformations 308a-c are not limited to visually representing all of the changes between the snapshots 304a-d. Instead, according to certain embodiments of the present disclosure, the transformations 308a-c may represent only certain ones of the changes. In this regard, a user may customize the transformations 308a-c to visually represent only changes of interest. As a result, the graphical comparison 204 may be tailored to suit particular needs of the user.

The processor 212 of the server 202 is further configured to generate the graphical comparison 204 of the data files 206a, 206b, . . . 206n or snapshots 304a-d. The processor 212 configures the graphical comparison 204 to visualize the change or changes between the data files 206a, 206b, . . . 206n or snapshots 304a-d by executing the transformations 308a-c.

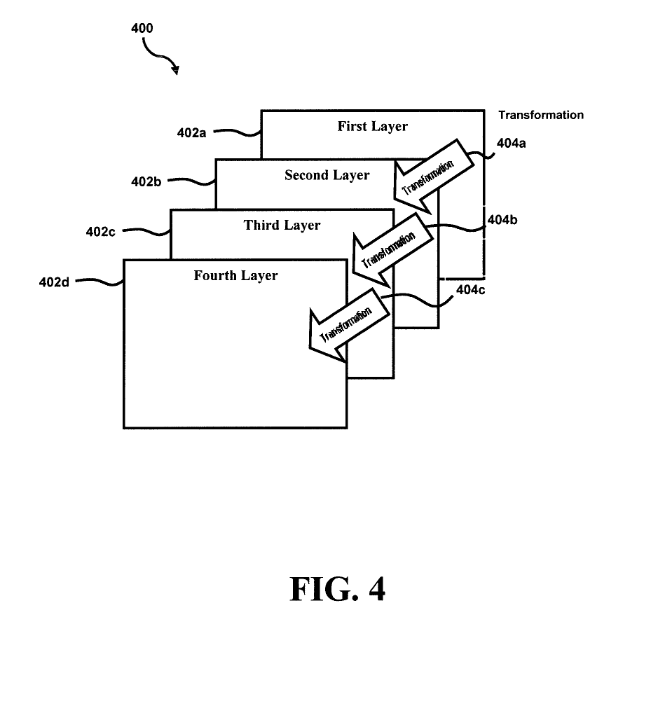

An exemplary embodiment of the graphical comparison 204 is generally shown at 400 in FIG. 4. The exemplary graphical comparison 400 of FIG. 4 includes a plurality of layers 402a-d, each of which corresponds to one of the snapshots 304a-d of FIG. 3. Of course, those skilled in the art appreciate that the layers 402a-d may each correspond to the data files 206a, 206b, . . . 206n in further embodiments of the exemplary graphical comparison 400.

The exemplary graphical comparison 400 of FIG. 4 allows the transformations 308a-c to be visualized between the layers 402a-d by executing the predefined transformation operations defined by the transformations 308a-c. The exemplary graphical comparison 400 is very intuitive and aesthetically pleasing. Moreover, since the exemplary graphical comparison 400 is configured to visualize the change or changes between the snapshots 304a-d or data files 206a, 206b, . . . 206n by executing the transformations 308a-c, the exemplary graphical comparison 400 does not need to include data or an image of each of the snapshots 304a-d or data files 206a, 206b, . . . 206n. That is, provided that the exemplary graphical comparison includes a single one of the snapshots 304a-d or data files 206a, 206b, . . . 206n, the exemplary graphical comparison 400 is configured to generate the additional snapshots 304a-d or data files 206a, 206b, . . . 206n from the known snapshot or data file by executing the transformations 308a-c.

According to the embodiment of the exemplary graphical comparison 400 as shown in FIG. 4, the exemplary graphical comparison 400 is configured to switch from displaying one of the layers 402a-d that corresponds to one of the snapshots 304a-d or data files 206a, 206b, . . . 206n to displaying another of the layers 402a-d that corresponds to another of the snapshots 304a-d or data files 206a, 206b, . . . 206n in response to a predetermined operation. The predetermined operation may be, for example, a scrolling operation, a keyboard input, or a voice command. Of course, those skilled in the art appreciate that the above-listed operations are merely exemplary and are not meant to be limiting.

According to the exemplary schematic 300 of FIG. 3, the first snapshot 304a, comprising the empty string, may be initially displayed by the exemplary graphical comparison 400 as a first layer 402a. Then, in response to a scrolling operation, for example, the first transformation 308a would be executed to visualize the changes between first snapshot 304a and the second snapshot 304b. For example, the string of “I am a boy” of the second snapshot 304b would appear on a superimposed second layer 402b while the first layer 402a would move to the background. Upon further scrolling, the words “I”, “am”, and “a” from the second layer 402b would move to a new, superimposed third layer 402c, and the words “am” and “a” would move apart to make room for the words “not” and “girl” of the third snapshot 304c. Upon even further scrolling, the word “not” of the third layer 402c dissolves into the background with the third layer 402c and does not appear on a new, superimposed fourth layer 402d. The words “I”, “am”, “a”, and “girl” appear on the superimposed fourth layer 402d, and the words “am” and “a” move closer together to fill the gap.

Of course, those skilled in the art appreciate that the above-described example is merely exemplary and not limiting. For example, the above-described example describes a new layer as being superimposed on a previous layer, with the previous layer moving to the background. Nevertheless, in additional embodiments of the exemplary graphical comparison 400, the new layer may move from the background to the foreground, with the previous layer moving to the foreground and disappearing. Alternatively, the layers 402a-d may be arranged in a circular configuration such that the layers 402a-d rotate, either clockwise or counterclockwise, in accordance with the predetermined operation.

According to an embodiment of the exemplary graphical comparison 400, one of the transformations 308a-c may be automatically executed when the exemplary graphical comparison 400 switches between the layers 402a-d. In this regard, the corresponding one of the transformations 308a-c, including each of the predefined transformation operations, may be instantly executed. Alternatively, the corresponding one of the transformations 308a-c may be executed over a period of time. According to one embodiment of the exemplary graphical comparison 400, one of the predefined transformation operations may be executed each predetermined period of time. The predetermined period of time may be constant for each of the predefined transformation operations, or the predetermined period of time may be variable amongst the predefined transformation operations.

In even further embodiments of the exemplary graphical comparison 400, each of the predefined transformation operations of one of the transformations 308a-c may be executed in accordance with a second predetermined operation. The second predetermined operation may be received by the server 202 from the client terminal 214. The second operation may be the same as the predetermined operation described herein, or the second operation may be distinct from the predetermined operation. In this regard, the predetermined operation may only transition the exemplary graphical comparison 400 from one of the layers 402a-d to another of the layers 402a-d, while the second predetermined operation causes the exemplary graphical comparison 400 to execute the transformations 308a-c.

Alternatively, the predetermined operation may transition the exemplary graphical comparison 400 from one of the layers 402a-d to another of the layers 402a-d while also executing the first predefined transformation operation of the transformations 308a-c, while the second predetermined operation causes the exemplary graphical comparison 400 to execute the remaining predefined transformation operations of the transformations 308a-c. According to such an embodiment, changes between the snapshots 304a-d or data files 206a, 206b, . . . 206n may be more clearly visualized by the exemplary graphical comparison 400 be configuring the exemplary graphical comparison 400 to step through the changes.

According to an embodiment of the present disclosure, the exemplary graphical comparison 400 is searchable based on the predefined transformation operations. As such, the exemplary graphical comparison 400 is configured to locate and display desired information more efficiently.

According to another embodiment of the present disclosure, the exemplary graphical comparison 400 is filterable based on the predefined transformation operations. In this regard, the exemplary graphical comparison 400 is configured to display relevant and desired information more efficiently and clearly.

In embodiments of the present disclosure, the exemplary graphical comparison 400 may be configured to execute the predefined transformation operations of the transformations 308a-c in an order corresponding to an order in which changes are made between the snapshots 304a-d or data files 206a, 206b, . . . 206n. Alternatively, the exemplary graphical comparison 400 may be configured to execute the predefined transformation operations in accordance with a priority order assigned to the predefined transformation operations. In even further embodiments, the exemplary graphical comparison 400 may be configured to execute the predefined transformation operations based upon a location within the snapshots 304a-d or data files 206a, 206b, . . . 206n, or based upon a proximity to a location of other predefined transformation operations.

According to one embodiment of the present disclosure, the exemplary graphical comparison 400 may display the entirety of each of the snapshots 304a-d or data files 206a, 206b, . . . 206n in the corresponding layers 402a-d. In additional embodiments of the present disclosure, the exemplary graphical comparison 400 may display only the change or changes between the snapshots 304a-d or data files 206a, 206b, . . . 206n, or the exemplary graphical comparison 400 may display the change or changes within the context of the snapshots 304a-d or data files 206a, 206b, . . . 206n.

The exemplary graphical comparison 400 may be configured to display the transformations 308a-c, the computed relationships 306a-c, or both. In this regard, the exemplary graphical comparison 400 may display the transformations 308a-c, the relationships 306a-c, or both within the layers 402a-d. Alternatively, as shown in FIG. 4, the exemplary graphical comparison 400 may include a separate display area 404a-c for displaying the transformations 308a-c, the relationships 306a-c, or both.

In further embodiments of the present disclosure, as shown in FIG. 3, the processor 212 is further configured to compute reverse transformations 310a-c based on the relationships 306a-c between the snapshots 304a-d, or the data files 206a, 206b, . . . 206n. The reverse transformations 310a-c may be computed in accordance with the predefined transformation operations, or the reverse transformations 310a-c may be computed in accordance with a different set of predefined reverse transformation operations. In any event, the reverse transformations 310a-c each comprise at least one operation that is executable for visually representing the change or changes between the snapshots 304a-d or data files 206a, 206b, . . . 206n in the opposite direction as the transformations 308a-c.

For example, while the second transformation 308b is executable for visually representing the change or changes between the second snapshot 304b and the third snapshot 304c, the second reverse transformation is executable for visually representing the change or changes between the third snapshot 304c and the second snapshot 304b, when transitioning from the third snapshot 304c to the second snapshot 304b. In this regard, the exemplary graphical comparison 400 of FIG. 4 may be configured to visualize the change or changes between the third snapshot 304c and the second snapshot 304b by executing the reverse transformation.

Thus, according to the embodiments of the present disclosure in which the reverse transformations 310a-c are computed, the layers 402a-d of the exemplary graphical comparison 400 may be traversed in both forward and reverse directions. That is, the changes between the snapshots 304a-d or the data files 206a, 206b, . . . 206n may be viewed as if they are being made and as if they are being undone.

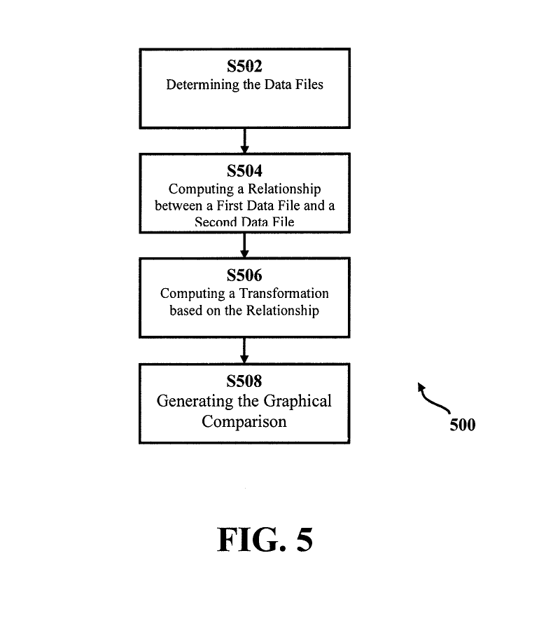

FIG. 5 shows a further embodiment of the present application. A method for generating a graphical comparison of data files is generally shown at 500. At S502, a plurality of data files is determined from a document with at least one processor. Each of the data files is a snapshot of the document determined in accordance with a predetermined criteria. A relationship between a first data file of the data files and a second data file of the data files is computed at S504 with the processor. The relationship represents at least one change from the first data file to the second data file. A transformation is computed in accordance with predefined transformation operations based on the relationship between the first data file and the second data file at S506 with the processor. The transformation comprises at least one of the predefined transformation operations and is executable for visually representing the change from the first data file to the second data file. The graphical comparison of the data files is generated at S508 with the processor. The graphical comparison is configured to visualize the at least one change from the first data file to the second data file by executing the transformation.

According to an embodiment of the method, the graphical comparison includes a plurality of layers that each correspond to one of the data files. The graphical comparison is configured to switch from displaying a first layer of the plurality of layers that corresponds to the first data file to displaying a second layer of the plurality of layers that corresponds to the second data file in response to a predetermined operation. Moreover, the graphical comparison is configured to execute the transformation after switching from displaying the first layer to displaying the second layer to visualize the at least one change from the first data file to the second data file.

Even further embodiments of the present application provide various non-transitory computer-readable media for generating a graphical comparison of data files. The various non-transitory computer-readable media may comprise the memory 106 of the computer system 102, be readable by the medium reader 112 of the computer system 102, or be readable by the additional computer device 120. In this regard, the non-transitory computer-readable media may comprise any media known and understood in the ail.

According to an embodiment of the non-transitory computer-readable media, the non-transitory computer-readable medium includes an executable program for generating a graphical comparison of data files. The executable program, when executed, causes a computer to determine a plurality of data files from a document. Each of the data files is a snapshot of the document determined in accordance with a predetermined criteria. The executable program further causes the computer to compute a relationship between a first data file of the data files and a second data file of the data files. The relationship represents at least one change from the first data file to the second data file. Then, the executable program causes the computer to compute, in accordance with predefined transformation operations, a transformation based on the relationship between the first data file and the second data file. The transformation comprises at least one of the predefined transformation operations and is executable for visually representing the change from the first data file to the second data file. Thereafter, the executable program causes the computer to generate the graphical comparison of the data files. The graphical comparison is configured to visualize the at least one change from the first data file to the second data file by executing the transformation.

According to an embodiment of the method, the graphical comparison includes a plurality of layers that each correspond to one of the data files. The graphical comparison is configured to switch from displaying a first layer of the plurality of layers that corresponds to the first data file to displaying a second layer of the plurality of layers that corresponds to the second data file in response to a predetermined operation. Moreover, the graphical comparison is configured to execute the transformation after switching from displaying the first layer to displaying the second layer to visualize the at least one change from the first data file to the second data file.

Those skilled in the art, of course, appreciate that the various features and embodiments of the above-described system 200 and server 202 may be incorporated into the above-described method and media without departing from the scope of the application. Moreover, those skilled in the art appreciate that the various features and embodiments of the above-described system 200 and server 202 may be implemented as a program or code segment which are executable for causing a server, computer, or system to operate in accordance with the above-described system 200.

Accordingly, the present invention provides various systems, servers, methods, media, and programs for generating a graphical comparison of data files. Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, the present disclosure generally describes the snapshots as comprising textual data. In this regard, it is to be understood that the snapshots may comprise image data and that the relationships and transformations may represent changes in the image data. For example, the relationships and transformations may represent changes in pixel coordinates, brightness, color, hue, etc.

While the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A server for generating a graphical comparison of data files, comprising:
at least one memory storing predefined transformation operations; and
at least one processor configured to:
compute a relationship between a first data file of the data files and a second data file of the data files, the relationship representing at least one change from the first data file to the second data file;
compute, in accordance with the predefined transformation operations, a transformation based on the relationship between the first data file and the second data file, the transformation comprising at least one of the predefined transformation operations and being executable for visually representing the at least one change from the first data file to the second data file; and
generate the graphical comparison of the data files, the graphical comparison configured to visualize the at least one change from the first data file to the second data file by executing the transformation.

2. The server according to claim 1, wherein
the graphical comparison includes a plurality of layers that each correspond to one of the data files, and
the graphical comparison is configured to switch from displaying a first layer of the plurality of layers that corresponds to the first data file to displaying a second layer of the plurality of layers that corresponds to the second data file in response to a predetermined operation.

3. The server according to claim 2, wherein the graphical comparison is configured to execute the transformation after switching from displaying the first layer to displaying the second layer.

4. The server according to claim 2, wherein
the transformation comprises a plurality of the predefined transformation operations, and
the graphical comparison is configured to execute one of the plurality of the predefined transformation operations of the transformation after switching from displaying the first layer to displaying the second layer in response to a second predetermined operation.

5. The server according to claim 2, wherein
the at least one processor is further configured to compute, in accordance with the predefined transformation operation, a reverse transformation based on the relationship between the first data file and the second data file, the reverse transformation comprising at least one of the predefined transformation operations and being executable for visually representing the at least one change from the second data file to the first data file, and
the graphical comparison is configured to visualize the at least one change from the second data file to the first data file by executing the reverse transformation.

6. The server according to claim 5, wherein the graphical comparison is configured to switch from displaying the second layer that corresponds to the first data file to displaying the first layer that corresponds to the second data file in response to a second predetermined operation.

7. The server according to claim 5, wherein the graphical comparison is configured to display the transformation and the reverse transformation.

8. The server according to claim 1, wherein the processor is further configured to determine each of the data files, the data files being snapshots of a document determined in accordance with a predetermined criteria.

9. The server according to claim 8, wherein the first data file and the second file are consecutive ones of the snapshots.

10. The server according to claim 8, wherein the first data file and the second file are inconsecutive ones of the snapshots.

11. The server according to claim 8, wherein the processor is configured to determine a new one of the data files when a predetermined number of the predefined transformation operations is determined to exist between the first data file and the second data file.

12. The server according to claim 1, further comprising:
an input for receiving each of the predefined transformation operations.

13. The server according to claim 12, wherein the predefined transformation operations comprise at least one of an appear operation, a disappear operation, a moveApart operation, and a comeCloser operation.

14. The server according to claim 1, further comprising:
a network interface that is configured to receive at least the first data file and the second data file via a network and to transmit the graphical comparison via the network.

15. The server according to claim 1, wherein the graphical comparison is at least one of searchable and filterable based on the predefined transformation operations.

16. The server according to claim 1, wherein
the first data file and the second data file include image data, and
the graphical comparison is configured to visualize the at least one change in the image data from the first data file to the second data file by executing the transformation.

17. A computer-implemented method for generating a graphical comparison of data files, comprising:
computing, with at least one processor, a relationship between a first data file of the data files and a second data file of the data files, the relationship representing at least one change from the first data file to the second data file;
computing, in accordance with predefined transformation operations, a transformation based on the relationship between the first data file and the second data file, the transformation comprising at least one of the predefined transformation operations and being executable for visually representing the at least one change from the first data file to the second data file; and
generating, with the at least one processor, the graphical comparison of the data files, the graphical comparison configured to visualize the at least one change from the first data file to the second data file by executing the transformation.

18. The computer-implemented method according to claim 17, wherein
the graphical comparison includes a plurality of layers that each correspond to one of the data files,
the graphical comparison is configured to switch from displaying a first layer of the plurality of layers that corresponds to the first data file to displaying a second layer of the plurality of layers that corresponds to the second data file in response to a predetermined operation, and
the graphical comparison is configured to execute the transformation after switching from displaying the first layer to displaying the second layer.

19. A non-transitory computer-readable medium including an executable program for generating a graphical comparison of data files, the executable program, when executed, causing a computer to execute:
computing, with at least one processor, a relationship between a first data file of the data files and a second data file of the data files, the relationship representing at least one change from the first data file to the second data file;
computing, in accordance with predefined transformation operations, a transformation based on the relationship between the first data file and the second data file, the transformation comprising at least one of the predefined transformation operations and being executable for visually representing the at least one change from the first data file to the second data file; and
generating, with the at least one processor, the graphical comparison of the data files, the graphical comparison configured to visualize the at least one change from the first data file to the second data file by executing the transformation.

20. The non-transitory computer-readable medium according to claim 19, wherein
the graphical comparison includes a plurality of layers that each correspond to one of the data files,
the graphical comparison is configured to switch from displaying a first layer of the plurality of layers that corresponds to the first data file to displaying a second layer of the plurality of layers that corresponds to the second data file in response to a predetermined operation, and
the graphical comparison is configured to execute the transformation after switching from displaying the first layer to displaying the second layer.
